(19) United States
(12) Patent Application Publication
(10) Pub. No.: US 2023/0234195 A1
(43) Pub. Date: Jul. 27, 2023

(54) VALVE STEM INSERTION DEVICE

(71) Applicant: Michael Larkin, Beaverton, MI (US)

(72) Inventor: Michael Larkin, Beaverton, MI (US)

(21) Appl. No.: 17/648,946

(22) Filed: Jan. 26, 2022

(51) Int. Cl. B25B 27/02; B60C 29/02

(52) U.S. Cl. CPC B25B 27/023; B60C 29/02

(57) ABSTRACT

A tire valve stem insertion device and a method of using.

### CROSS-REFERENCE TO RELATED APPLICATIONS

Not Applicable.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Various valve stem insertion devices and related devices are known in the art. For example, U.S. Pat. No. 4,807,343 that issued Feb. 28, 1989, to Wadsworth, et al., teaches a tool for installing valve stems in the rim for tubeless tires from the outside of the rim.

U.S. Pat. No. 7,017,247 that issued Mar. 26, 2006, to Detzel et al., teaches a simple kit for removal and insertion of valve stems for tubeless tires while the tire remains mounted on the rim.

U.S. Pat. No. 9,616,719 that issued Apr. 11, 2017, to Jensen et al., teaches a valve cap and core tool that has an elongated shaft terminated by a valve core head at one end and a valve cap head at a second end.

U.S. Pat. No. 9,272,588 that issued Mar. 1, 2016, to Groom et al., teaches a method for replacing a leaking valve stem that includes the steps of cutting a part of the valve stem external to a hollow interior of a tire at the external surface of a wheel/rim so that a base of the valve stem falls into the hollow interior of the tire and so that wheel aperture is exposed.

U.S. Pat. No. 4,765,048 issued Aug. 23, 1988 to Hokanson et al., teaches a tool for inserting valve stems in the wheel rim of a tubeless tire and wheel combinations that comprises a tubular body having a tapered inner peripheral wall and an end portion adapted to be received in the stem hole of the wheel rim.

U.S. Pat. No. 6,574,843 issued on Jun. 10, 2003 to Meadows et al., teaches a method and apparatus for installing and replacing a valve stem from the valve stem rim opening defined in the rim of a tubeless tire from the outside of the rim, such tool includes a threaded rod for engaging the valve stem through an inwardly tapered first tube into a second tube dimensioned to fit into the valve stem rim opening, the flange of the valve stem is gradually compressed. After the tapered tube is removed the second tube is placed in the rim opening and the valve stem is pushed into the valve stem opening using manual force.

U.S. Pat. No. 5,097,580 issued on Mar. 24, 1992, to Story et al., teaches an apparatus for removing and installing a valve stem into an opening defined by a rim. An inoperable valve stem is removed from the rim from the outside of the rim, and an operable valve stem is installed into the rim from the outside of the rim, thus avoiding separating the tire side wall from the rim during the removal and installation of the valve stem.

### BRIEF SUMMARY OF THE INVENTION

The instant invention is a tire valve stem insertion device. The device comprises a housing. The housing has a top and a bottom. The top has a cover with a center threaded opening. This center threaded opening has a threaded rod inserted therein and a lower terminal end of the threaded rod terminates in a threaded fitting for mating with the threaded end of a conventional tubeless tire valve stem. The bottom has a cone-shaped extension. The cone-shaped extension is coupled to the bottom by a Luer-Lock® style mechanism. “Luer-Lock is a registered trademark of Becton Dickinson, Franklin Lakes, N.J. The cone-shaped extension has walls that converge towards a tip end. The tip end is smaller in diameter than the diameter of an enlarged base of the conventional tubeless tire valve stem.

The present invention is a method of providing a tubeless tire with a tire valve stem. The method comprises removing the extension from the tire valve stem insertion device by activating the Luer-Lock style mechanism. Then threading a conventional tubeless tire valve stem onto the terminating end of the threaded rod. Then replacing the extension on the tire valve stem insertion device by using the Luer-Lock style mechanism. Then threading the threaded rod to push the tire valve stem into an opening in a tubeless tire rim until an enlarged base of the conventional tubeless tire valve stem is inserted and seated in the opening.

### BRIEF DESCRIPTION OF THE SEVERAL VIEWS OF THE DRAWINGS

FIG. 1 is a full side view of a valve stem insertion device of this invention.

FIG. 2 is a cross sectional view of a valve stem insertion device through line A-A of FIG. 1 showing the center threaded opening.

FIG. 3 is a full cross-sectional view of the device of FIG. 1 along line A-A of FIG. 1.

### DETAILED DESCRIPTION OF THE INVENTION AND DRAWINGS

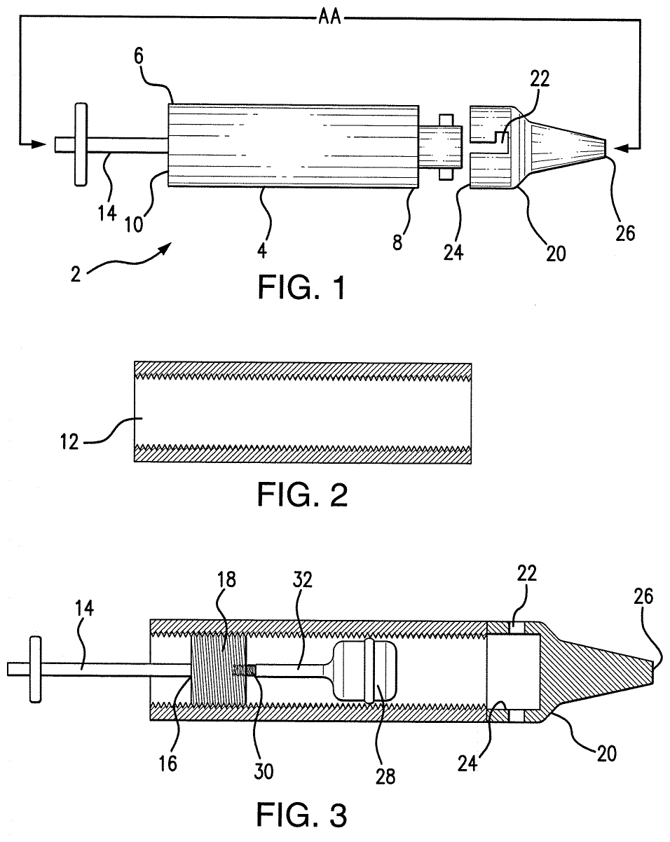

FIG. 1 shows a valve stem insertion device 2 of this invention. The instant invention is a tire valve stem insertion device 2. The device 2 comprises a housing 4. The housing 4 has a top end 6 and a bottom end 8. The top end 6 has a cover 10 with a center threaded opening 12 (shown if FIG. 2). This center threaded opening 12 (FIG. 2) has a rod 14 inserted therein and a lower terminal end 16 of the rod 14 (shown in FIG. 3) terminates in a threaded fitting 18 (shown in FIG. 3) for mating with the threaded end 30 (shown in FIG. 3) of a conventional tubeless tire valve stem 32 (shown in FIG. 3).

The bottom 8 has a cone-shaped extension 20. The cone-shaped extension 20 is coupled to the bottom 8 by a Luer-Lock style mechanism 22 shown in FIG. 1. The cone-shaped extension 20 has walls 24 that converge towards a tip end 26. The tip end 26 is smaller in diameter than the diameter of an enlarged base 28 (shown in FIG. 3) of the conventional tubeless tire valve stem 32.

FIG. 2 shows the center threaded opening 12 of the housing 4 of the valve stem insertion device.

FIG. 3 shows the valve stem insertion device 2 with a valve stem 32 within for insertion. The present invention is a method of providing a tubeless tire with a tire valve stem 32. The method comprises removing the extension 20 from the tire valve stem insertion device 2 by activating the Luer-Lock style mechanism 22. Then threading a conventional tubeless tire valve 32 stem onto the terminating end 16 of the threaded rod 14. Then replacing the extension 20 on the tire valve stem insertion device 2 by using the Luer-Lock style mechanism 22. Then turning the rod 14 to turn the threaded portion 18 through the housing 4 to push the tire valve stem 32 into an opening in a tubeless tire rim until an enlarge base 28 of the conventional tubeless tire valve stem 32 is inserted and seated in the opening.

The device of this invention can be manufactured from metal or plastic. The device is low cost to manufacture, lightweight so it can be carried by a workman, and requires no high pressure to operate.

1. A tire valve stem insertion device, said device comprising:
a) a housing, said housing having a top and a bottom, said top having a cover with a center threaded opening;
b) said center threaded opening having a rod inserted therein, a lower terminal end of said rod terminating in a threaded fitting for mating with the threaded end of a conventional tubeless tire valve stem;
c) said bottom having a cone-shaped extension, said cone-shaped extension being coupled to said bottom by a Luer-Lock style mechanism, said cone-shaped extension having walls that converge towards a tip end, said tip end being smaller in diameter than the diameter of an enlarged base of said conventional tubeless tire valve stem.

2. A method of providing a tubeless tire with a tire valve stem insertion device as claimed in claim 1, the method comprising:
i) removing said extension from the tire valve stem insertion device by activating said Luer-Lock style mechanism;
ii) threading a conventional tubeless tire valve stem onto said terminating end of said rod;
iii) replacing said extension on said tire valve stem insertion device by using said Luer-Lock style mechanism;
iv) turning said rod to push said tire valve stem into an opening in a tubeless tire rim until an enlarge base of said conventional tubeless tire valve stem is inserted and seated in said opening.
